(19) United States
(12) Patent Application Publication
(10) Pub. No.: US 2011/0134768 A1
(43) Pub. Date: Jun. 9, 2011

(54) NETWORK ANALYSIS USING NETWORK EVENT DATA

(75) Inventors: JACOBUS VAN DER MERWE, New Providence, NJ (US); Seungjoon Lee, Springfield, NJ (US); Carsten Lund, Berkeley Heights, NJ (US); Jennifer Yates, Morristown, NJ (US)

(73) Assignee: AT&T INTELLECTUAL PROPERTY I, L.P., Reno, NV (US)

(21) Appl. No.: 12/633,447

(22) Filed: Dec. 8, 2009

(51) Int. Cl. H04L 12/26

(52) U.S. Cl. 370/252

(57) ABSTRACT

A system that incorporates teachings of the present disclosure may include, for example, network device having a controller to combine network data sources enabling simplified database queries across a plurality of data sources, normalize the data from the plurality of data sources, continuously collect routing information between two routers of interest, selectively and automatically extract network data involving network events and routing, determine a temporal correlation among identified network events, determine a spatial correlation among identified network events, and troubleshoot an interactive media service based on a combination of the temporal correlation and the spatial correlation determined between the defined edge routers. Other embodiments are disclosed.

### FIELD OF THE DISCLOSURE

The present disclosure relates generally to communication networks and more specifically to a method and system of network analysis using network event data.

### BACKGROUND

Network operators, in particular tier 3 support staff, are routinely called on to investigate network events that might have impacted a few customers but might not have been recorded as major networking events. For example, while routing changes (e.g. caused by operational procedures and/or link failures) would typically go unnoticed by most customers, it might be noticed by some customers (especially those who have sensitive applications). Such customers might then demand an explanation of what caused the event.

The in current network operations tasks such as these are normally carried out manually after the fact such as when a customer complaint is received. In such instances, a support person would typically be assigned to the task of attempting to collect network information in an attempt to uncover the root cause. This is both time consuming and error prone. Specifically, at the time of the investigation, things might have changed in the network so that the path a customer's traffic now follows might be completely different from the path that was followed during the network event that caused the customer to complain.

### BRIEF DESCRIPTION OF THE DRAWINGS

FIG. 1 depicts an illustrative embodiment of a communication system;

FIG. 2 depicts an illustrative embodiment of a portal interacting with the communication system of FIG. 1;

FIG. 3 depicts an illustrative embodiment of a communication device utilized in the communication system of FIG. 1;

FIG. 4 depicts an illustrative embodiment of a method operating in portions of the communication system of FIG. 1;

FIG. 5 depicts an illustrative communication system that can be monitored and analyzed in accordance with the embodiments;

FIG. 6 depict a module used in the analysis of the communication network of FIG. 5; and

FIG. 7 is a diagrammatic representation of a machine in the form of a computer system within which a set of instructions, when executed, may cause the machine to perform any one or more of the methodologies discussed herein.

### DETAILED DESCRIPTION

One embodiment of the present disclosure can entail a method at a network element that identifies network events between defined edge routers in interactive media services, determines a temporal correlation among identified network events, determines a spatial correlation among identified network events, and troubleshoots the interactive media services based on a combination of the temporal correlation and the spatial correlation determined between the defined edge routers.

Another embodiment of the present disclosure can entail a computer-readable storage medium in a network element having computer instructions for identifying network events between given routers in an interactive media service, determining a temporal correlation among identified network events, determining a spatial correlation among identified network events, and troubleshooting the interactive media service based on a combination of the temporal correlation and the spatial correlation determined between the given routers.

Yet another embodiment of the present disclosure can entail a network device comprising a controller to combine network data sources enabling simplified database queries across a plurality of data sources, normalize the data from the plurality of data sources, continuously collect routing information between two routers of interest, selectively and automatically extract network data involving network events and routing, determine a temporal correlation among identified network events, determine a spatial correlation among identified network events, and troubleshoot an interactive media service based on a combination of the temporal correlation and the spatial correlation determined between the defined edge routers.

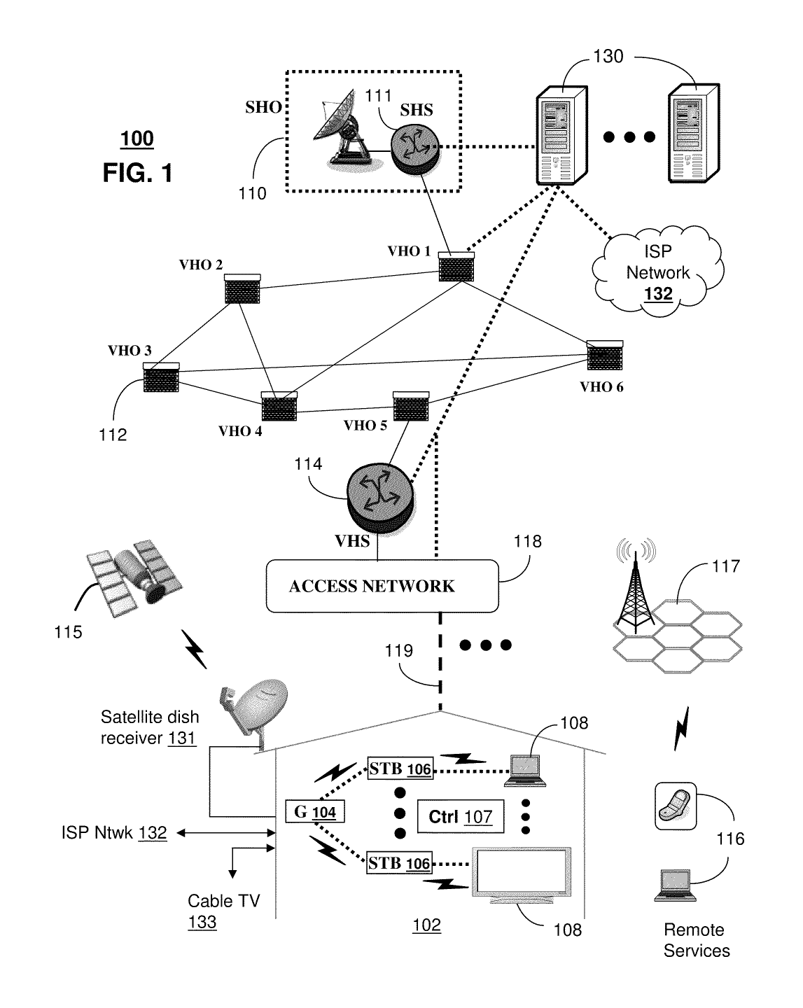

FIG. 1 depicts an illustrative embodiment of a first communication system 100 for delivering media content. The communication system 100 can represent an Internet Protocol Television (IPTV) broadcast media system for example, but other systems (such as interactive TV and virtual private networks among others) are certainly contemplated within the embodiments herein. The IPTV media system can include a super head-end office (SHO) 110 with at least one super headend office server (SHS) 111 which receives media content from satellite and/or terrestrial communication systems. In the present context, media content can represent audio content, moving image content such as videos, still image content, or combinations thereof. The SHS server 111 can forward packets associated with the media content to video head-end servers (VHS) 114 via a network of video head-end offices (VHO) 112 according to a common multicast communication protocol.

The VHS 114 can distribute multimedia broadcast programs via an access network 118 to commercial and/or residential buildings 102 housing a gateway 104 (such as a common residential or commercial gateway). The access network 118 can represent a group of digital subscriber line access multiplexers (DSLAMs) located in a central office or a service area interface that provide broadband services over optical links or copper twisted pairs 119 to buildings 102. The gateway 104 can use common communication technology to distribute broadcast signals to media processors 106 such as Set-Top Boxes (STBs) which in turn present broadcast channels to media devices 108 such as computers or television sets managed in some instances by a media controller 107 (such as an infrared or RF remote control).

The gateway 104, the media processors 106, and media devices 108 can utilize tethered interface technologies (such as coaxial or phone line wiring) or can operate over a common wireless access protocol. With these interfaces, unicast communications can be invoked between the media processors 106 and subsystems of the IPTV media system for services such as video-on-demand (VoD), browsing an electronic programming guide (EPG), or other infrastructure services.

Some of the network elements of the IPTV media system can be coupled to one or more computing devices 130 a portion of which can operate as a web server for providing portal services over an Internet Service Provider (ISP) network 132 to wireline media devices 108 or wireless communication devices 116 by way of a wireless access base station 117 operating according to common wireless access protocols such as Wireless Fidelity (WiFi), or cellular communication technologies (such as GSM, CDMA, UMTS, WiMAX, Software Defined Radio or SDR, and so on).

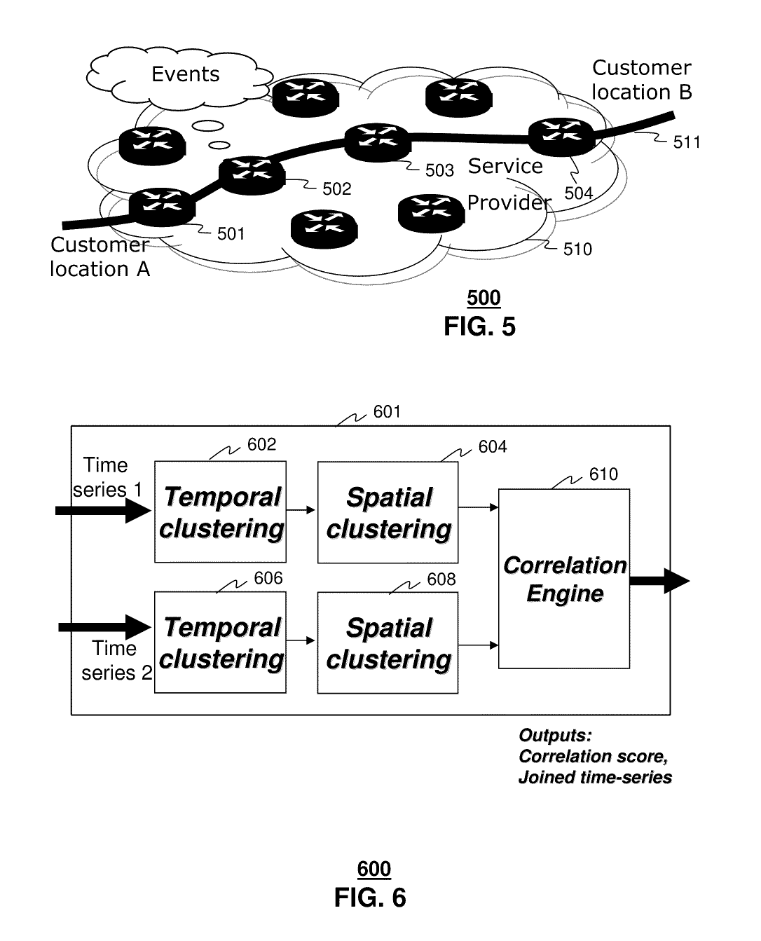

FIGS. 5 and 6 illustrate additional portions 500 and 600 respectively of a communication network used in the analysis of a network event. For example, a typical network can be a service provider network 510 having a plurality of routers 501, 502, 503, and 504 among others. Routers 501-504 form a particular path 511 between a first customer location and a second customer location in the network 510. Events along the path can be tracked and correlated as will be further discussed in order to determine the root cause of issues presented on the network. As illustrated in FIG. 6, the correlation can be done using a correlation engine 610 that that correlates multiple time series and further performs temporal clustering 602 and spatial clustering 604 over at least a first time series and temporal clustering 606 and spatial clustering 608 over a second time series which is fed into the correlation engine 610 within module 601.

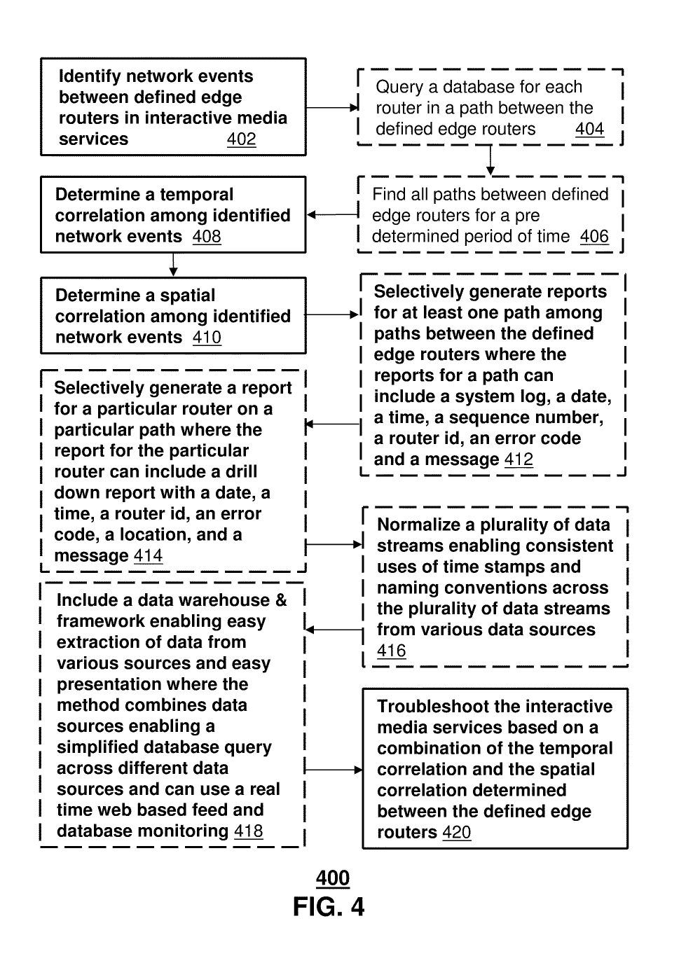

Another distinct portion of the computing devices 130 can function as a network device that performs the analysis described in FIG. 6. The device 130 can use common computing and communication technology to perform the function described above and further detailed in the flow chart in FIG. 4.

It will be appreciated by an artisan of ordinary skill in the art that a satellite broadcast television system can be used in place of the IPTV media system. In this embodiment, signals transmitted by a satellite 115 supplying media content can be intercepted by a common satellite dish receiver 131 coupled to the building 102. Modulated signals intercepted by the satellite dish receiver 131 can be submitted to the media processors 106 for generating broadcast channels which can be presented at the media devices 108. The media processors 106 can be equipped with a broadband port to the ISP network 132 to enable infrastructure services such as VoD and EPG described above.

In yet another embodiment, an analog or digital broadcast distribution system such as cable TV system 133 can be used in place of the IPTV media system described above. In this embodiment the cable TV system 133 can provide Internet, telephony, and interactive media services. Interactive media services can include for example an IP Multimedia Subsystem (IMS) network architecture to facilitate the combined services of circuit-switched and packet-switched systems. Such a communication system can be overlaid or operably coupled with communication system 100 as another representative embodiment.

It follows from the above illustrations that the present disclosure can apply to any present or future interactive over-the-air or landline media content services.

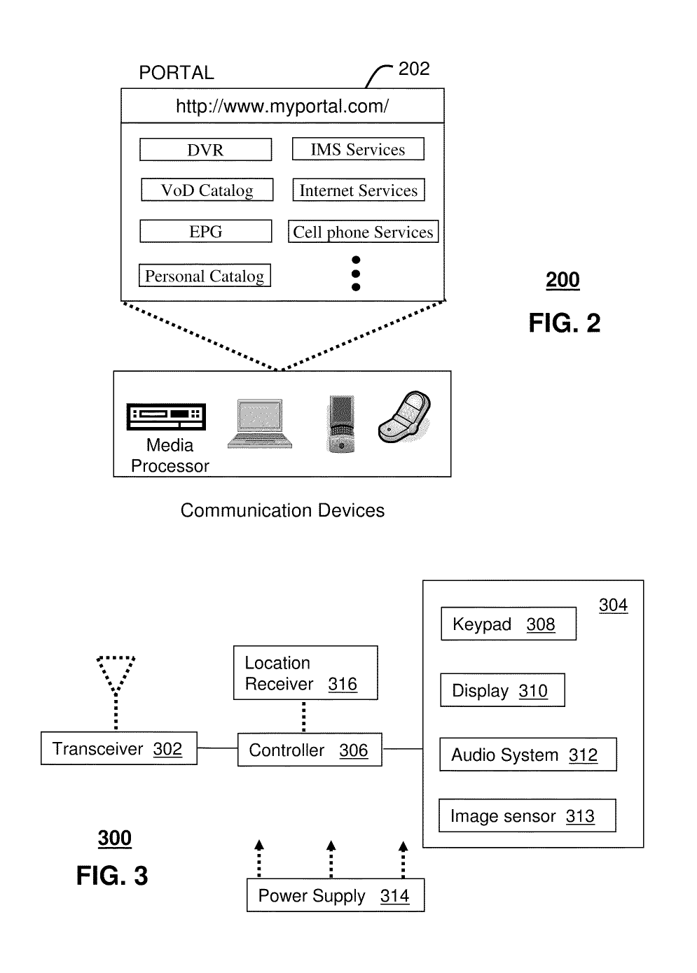

FIG. 2 depicts an illustrative embodiment of a portal 202 which can operate from the computing devices 130 described earlier of communication 100 illustrated in FIG. 1. The portal 202 can be used for managing services of communication systems 100-200. The portal 202 can be accessed by a Uniform Resource Locator (URL) with a common Internet browser such as Microsoft's Internet Explorer™ using an Internet-capable communication device such as those described for FIGS. 1-2. The portal 202 can be configured, for example, to access a media processor 106 and services managed thereby such as a Digital Video Recorder (DVR), a VoD catalog, an EPG, a personal catalog (such as personal videos, pictures, audio recordings, etc.) stored in the media processor, provisioning IMS services described earlier, provisioning Internet services, provisioning cellular phone services, and so on.

FIG. 3 depicts an exemplary embodiment of a communication device 300. Communication 300 can serve in whole or in part as an illustrative embodiment of the communication devices of FIGS. 1-2. The communication device 300 can comprise a wireline and/or wireless transceiver 302 (herein transceiver 302), a user interface (UI) 304, a power supply 314, a location receiver 316, and a controller 306 for managing operations thereof. The transceiver 302 can support short-range or long-range wireless access technologies such as Bluetooth, WiFi, Digital Enhanced Cordless Telecommunications (DECT), or cellular communication technologies, just to mention a few. Cellular technologies can include, for example, CDMA-1X, UMTS/HSDPA, GSM/GPRS, TDMA/EDGE, EV/DO, WiMAX, SDR, and next generation cellular wireless communication technologies as they arise. The transceiver 402 can also be adapted to support circuit-switched wireline access technologies (such as PSTN), packet-switched wireline access technologies (such as TCPIP, VoIP, etc.), and combinations thereof.

The UI 304 can include a depressible or touch-sensitive keypad 308 with a navigation mechanism such as a roller ball, joystick, mouse, or navigation disk for manipulating operations of the communication device 300. The keypad 308 can be an integral part of a housing assembly of the communication device 300 or an independent device operably coupled thereto by a tethered wireline interface (such as a USB cable) or a wireless interface supporting for example Bluetooth. The keypad 308 can represent a numeric dialing keypad commonly used by phones, and/or a Qwerty keypad with alphanumeric keys. The UI 304 can further include a display 310 such as monochrome or color LCD (Liquid Crystal Display), OLED (Organic Light Emitting Diode) or other suitable display technology for conveying images to an end user of the communication device 300. In an embodiment where the display 310 is touch-sensitive, a portion or all of the keypad 308 can be presented by way of the display.

The UI 304 can also include an audio system 312 that utilizes common audio technology for conveying low volume audio (such as audio heard only in the proximity of a human ear) and high volume audio (such as speakerphone for hands free operation). The audio system 312 can further include a microphone for receiving audible signals of an end user. The audio system 412 can also be used for voice recognition applications. The UI 304 can further include an image sensor 313 such as a charged coupled device (CCD) camera for capturing still or moving images.

The power supply 314 can utilize common power management technologies such as replaceable and rechargeable batteries, supply regulation technologies, and charging system technologies for supplying energy to the components of the communication device 300 to facilitate long-range or short-range portable applications. The location receiver 316 can utilize common location technology such as a global positioning system (GPS) receiver for identifying a location of the communication device 100 based on signals generated by a constellation of GPS satellites, thereby facilitating common location services such as navigation.

The communication device 100 can use the transceiver 402 to also determine a proximity to a cellular, WiFi or Bluetooth access point by common power sensing techniques such as utilizing a received signal strength indicator (RSSI) and/or a signal time of arrival (TOA) or time of flight (TOF). The controller 306 can utilize computing technologies such as a microprocessor, a digital signal processor (DSP), and/or a video processor with associated storage memory such a Flash, ROM, RAM, SRAM, DRAM or other storage technologies.

The communication device 300 can be adapted to perform the functions of the media processor 106, the media devices 108, or the portable communication devices 56 of FIG. 1. It will be appreciated that the communication device 300 can also represent other common devices that can operate in communication systems 100 of FIG. 1 such as a gaming console and a media player.

FIG. 4 depicts an illustrative method 400 that operates in portions of the communication system of FIG. 1 and in a network element of the communication system of FIG. 1. Method 400 can begin with step 402 in which network events between defined edge routers in an interactive media service (such as an Internet Protocol TV (IPTV) network) can be identified either automatically or manually. At 404, a database can be queried for each router in a path between the defined edge routers. At 406, all paths between the defined edge routers for a predetermined period of time can be found. Finding the paths can be done in a number of ways. For example, network paths can be calculated using historical routing data during the time of an identified network event where the historical routing data can be stored in a database. The historical routing data can be based on an OSPF routing message or an ISIS routing message. The actual network paths during an identified network event can also be determined by emulating protocol specific routing decisions. In some instances, network data can also be collected and used in reports and analysis on a real time basis.

The method determines a temporal correlation among identified network events at 408 and determines a spatial correlation among identified network events at 410. Then, the method can selectively generate reports for a particular path among a plurality of paths between the defined edge routers at 412 where the reports for the particular path include all or any among a system log, a date, a time, a sequence number, a router identifier, an error code and a message. At 414, the method can selectively generate a report for a particular router on a particular path where the report for the particular router can include a drill down report including all or any among a date, a time, a router identifier, an error code, a location, and a message or other network measurement. The method at 416 can further normalize a plurality of data streams enabling consistent uses of time stamps and naming conventions across the plurality of data streams from various data sources. The method can include a data warehouse and framework enabling easy extraction of data from various sources and easy presentation at 418 such that the method combines network data sources enabling a simplified database query across different data sources and can further use a real time web based feed and database monitoring. At 420, the method can then troubleshoot the network (such as an IPTV or iTV network or VPN among others) based on a combination of the temporal correlation and the spatial correlation determined between the defined edge routers. The method can include anomaly detection, scalable pair-wise correlation testing, end to end path calculations, and a reporting engine as well as network wide information correlation and statistical correlation testing. Other aspects can enable troubleshooting, chronic condition detection, and visualization.

Upon reviewing the aforementioned embodiments, it would be evident to an artisan with ordinary skill in the art that said embodiments can be modified, reduced, or enhanced without departing from the scope and spirit of the claims described below. For example, the embodiments are not necessarily limited to an IPTV or iTV network, but could be used with other networks, systems or architectures as well as networks, systems and architectures reasonably contemplated in the future.

In one particular aspect, the concepts herein can be embodied as a software tool in multi-data source framework. In the context of embodiments herein, the concepts can be thought of as operating in the context of a data warehouse and reporting framework that allows easy extraction of data from various data sources as well as the presentation of the results to users.

Specifically, network data sources can be combined in such a way as to simplify database queries across different data sources. Examples of relevant data sources can include SYSLOG data, routing data, TACACS data, and network performance data among others. The system would perform data normalization so that timestamps, names and other similar information are consistently used across all data sources. Within this context, the tools herein can operate as follows: 1) Using continuously collected routing information (stored in device 130 for example), the actual network path between two customer endpoints, at the time of the reported incident is calculated. 2) Using this path information, the data warehouse is consulted to extract relevant network data along the complete path or set of paths between the customer end points. 3) The reporting capabilities of the framework is used to present the results to an operator to allow them to easily inspect network data collected during the time of the reported event. In this manner, relevant network data is automatically extracted and presented to an operator with improved accuracy. Since the actual network path between customer endpoints is calculated, only data relevant to the event being investigated is extracted.

Other suitable modifications can be applied to the present disclosure without departing from the scope of the claims below. Accordingly, the reader is directed to the claims section for a fuller understanding of the breadth and scope of the present disclosure.

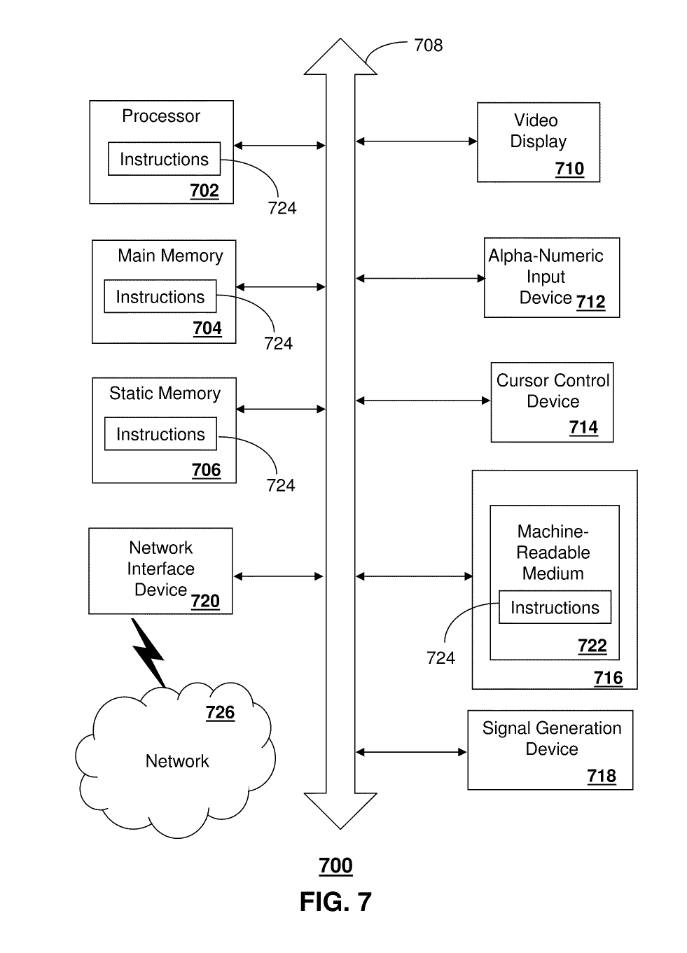

FIG. 7 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method at a network element, comprising:
automatically identifying network events between defined edge routers in interactive media services;
determining a temporal correlation among identified network events;
determining a spatial correlation among identified network events; and
troubleshooting the interactive media services based on a combination of the temporal correlation and the spatial correlation determined between the defined edge routers.

2. The method of claim 1, wherein the method further queries a database for events and logs associated with each router along a path or set of paths between the defined edge routers.

3. The method of claim 1, wherein the method finds all paths between the defined edge routers for a predetermined period of time.

4. The method of claim 3, wherein network paths are calculated using historical or real-time routing data during the time of an identified network event.

5. The method of claim 4, wherein the routing data is stored in a database.

6. The method of claim 5, wherein the historical routing data is based on an OSPF routing message or an ISIS routing message or BGP routing messages.

7. The method of claim 4, wherein actual network paths during the identified network event is determined by emulating protocol specific routing decisions.

8. The method of claim 1, wherein the method selectively generates reports for at least one path among a plurality of paths between the defined edge routers.

9. The method of claim 8, wherein the reports for the particular path comprises a system log, a date, a time, a sequence number, a router identifier, an error code and a message or measurement.

10. The method of claim 1, wherein the method selectively generates a report for at least one particular router on a particular path, wherein the report comprises a diverse set of data or data logs.

11. The method of claim 10, wherein the report for the particular router comprises at least a drill down report comprising a date, a time, a router identifier, an error code, a location, and a message or measurement.

12. The method of claim 1, wherein the method includes a data warehouse and framework enabling easy extraction of data from various sources and easy presentation.

13. The method of claim 1, wherein the method normalizes a plurality of data streams enabling consistent uses of time stamps and naming conventions across the plurality of data streams from various data sources.

14. The method of claim 1, wherein the method uses a real time web based feed and database monitoring.

15. A computer-readable storage medium in a network element, comprising computer instructions for:
identifying network events between given routers in an interactive media service;
determining a temporal correlation among identified network events;
determining a spatial correlation among identified network events; and
troubleshooting the interactive media servicebased on a combination of the temporal correlation and the spatial correlation determined between the given routers.

16. The computer-readable storage medium of claim 15, wherein the computer instructions further queries a database for each router in a path between the given routers and finds all paths between the given routers for a predetermined period of time.

17. A network device, comprising a controller to:
combine network data sources enabling simplified database queries across a plurality of data sources;
normalize the data from the plurality of data sources;
continuously collect routing information between two routers of interest;
selectively and automatically extract network data involving network events and routing;
determine a temporal correlation among identified network events;
determine a spatial correlation among identified network events; and
troubleshoot an an interactive media service based on a combination of the temporal correlation and the spatial correlation determined between the defined edge routers.

18. The network device of claim 17, wherein the network device combines network data sources enabling a simplified database query across different data sources.

19. The network device of claim 17, wherein the network device normalizes a plurality of data streams enabling consistent uses of time stamps and naming conventions across a plurality of data streams from various data sources.

20. The network device of claim 17, wherein the network device uses a real time web based feed and database monitoring to perform anomaly detection, scalable pair-wise correlation testing, and end to end path calculations to enable troubleshooting, chronic condition detection, and visualization and wherein the interactive media service can be based on IP Television (IPTV), interactive Television (iTV), virtual private networks (VPN), or IP Multimedia Subsystem (IMS) network architectures.
